(19) United States
(12) Patent Application Publication
(10) Pub. No.: US 2011/0289567 A1
(43) Pub. Date: Nov. 24, 2011

(54) SERVICE ACCESS CONTROL

(75) Inventors: Markus Bauer-Hermann, Aicha vorm Wald (DE); Gerald Meyer, Puchheim-Bhf (DE); Robert Seidl, Konigsdorf (DE)

(73) Assignee: NOKIA SIEMENS NETWORKS OY, Espoo (FI)

(21) Appl. No.: 13/128,244

(22) PCT Filed: Dec. 30, 2008
(86) PCT No.: PCT/EP2008/068352

§ 371 Date: Jul. 29, 2011

(51) Int. Cl. H04L 9/32

(52) U.S. Cl. 726/6

(57) ABSTRACT

A USB memory stick, or similar device, is provided having software installed thereon to enable a user to access restricted applications without a user device needing to handle user credential data. In use, the stick receives a request from the user device for access to an application, obtains first user identification information from the user device, uses the first user identification information and the application information to obtain user credentials from an identity management system, which user credentials are required by the application in order to grant the user access to the application, and provides the user credentials to the application without the user credentials needing to be provided to the user device.

The present invention is related to the field of identity management and service access control.

Many service providers require users to be identified in some way before access is granted to an application. A variety of mechanisms have been developed for identifying a user at a user device. Many identification schemes require the use of special hardware at the user device, such as a smartcard reader or a fingerprint reader. Smartcard and fingerprint readers both require that the relevant reader be installed at the user device; accordingly, such mechanisms are not readily portable and are therefore often device dependent. Another known identification scheme makes use of a Trusted Platform Module (TPM), which besides the required software, needs an additional chip to be provided at the end user device. Again, the additional hardware requirement results in TPM typically being device dependent.

Many other mechanisms for identifying a user require a user to enter data into a form. For example, a user may be required to enter a username/password pair or a one-time key. In some circumstances, users are identified by HTTP-Digest against an active directory or radius server. Typically, user access is controlled by the application being accessed. If a user wants to be registered for a new service, the new service has to be configured; for example, by setting a new user's access rights. The end user necessarily takes part in the authorisation and/or authentication process. Thus, the end device needs to be configured and maintained and, if the user uses a different end device, the procedure typically needs to be repeated.

In some identification schemes, the end user device not only takes part in the user identification procedure, but even holds some or all of the user access permission data. This is particularly problematic if the user device is shared between different users (as they are, for example, in an Internet café), since it opens the possibility that a later user of the device may be able to access the information required to gain access to restricted applications.

The storage of user credentials on a user device is sometimes used to assist users with access to secure services. By way of example, HTTP cookies can be stored locally to identify a user to a server that has been visited by the user before. However, although such methods can be convenient for users, they can also represent security risks, since a later user may be able to gain access to a previous user's credentials. Furthermore, information entered by a user to gain access to an application may be recorded by malicious software, such as Trojan horses, which, again, may enable another user to gain access to the user credentials of another user.

The present invention seeks to address at least some of the problems outlined above.

According to an aspect of the invention, there is provided an apparatus (such as an identity stick) comprising: a controller; a first interface adapted to enable the controller to communicate with a user device (for example, in order to obtain instructions regarding an application to be accessed and/or to obtain first user information); a second interface adapted to enable the controller to communicate with an identity management system in order to obtain user-specific attributes for the application; and a third interface adapted to enable the controller to communicate with the application in accordance with the user-specific attributes. Thus, the apparatus does not require the user-specific attributes obtained from the identity management system to be provided to the user device. In some forms of the invention, a particular single interface of the apparatus may implement more than one of the interfaces referred to above. For example, a single interface may provide the second interface (communicating with the IDM) and the third interface (communicating with the application).

In some forms of the invention, the first interface is adapted to receive instructions regarding an application to be accessed. The identity of the application may be used by the second interface when obtaining the user-specific attributes for the application. In some forms of the invention, the first interface is adapted to receive first user identification information from the user device. The first user identification information may be used when obtaining the user-specific attributes for the invention.

According to another aspect of the invention, there is provided a method comprising: receiving a request from a user device for access to an application, the request being received at a second device; using the second device to obtain user-specific attributes for the application from an identity management system (for example, by using the first user identification information and/or the application information); and using the second device to access the application in accordance with the user-specific attributes. Thus, the user-specific attributes for the application concerned do not need to be provided to the user device, thereby improving security.

The second device may be removably connected to the user device. The second device may be physically connected to the user device, for example using a connection such as a USB connection. Alternatively, the second device may be connected to the user device via a wireless connection.

According to a further aspect of the invention, there is provided an apparatus (such as an identity stick) comprising: means for receiving a request from a user device for access to an application; means for obtaining user-specific attributes for the application from an identity management system; and means for accessing the application in accordance with the user-specific attributes. Thus, the user-specific attributes do not need to be provided to the user device, thereby improving security. The apparatus of the invention may be removably connectable to the user device. In some embodiments of the invention, some of the elements of the invention may be combined. For example, the means for receiving a request from a user device and the means for obtaining first user identification information may be provided by a single hardware or software element.

According to another aspect of the invention, there is provided a computer program comprising: code for receiving a request from a user device for access to an application; code for obtaining user-specific attributes for the application from an identity management system (for example, by making use of the first user identification information and/or the application information); and code for accessing the application in accordance with the user-specific attributes. The computer program may be a computer program product comprising a computer-readable medium bearing computer program code embodied therein for use with a computer. The computer program may, for example, be provided on an identity stick or some other apparatus that may be removably connected to the user device.

According to a further aspect of the invention, there is provided a computer program product comprising: means for receiving a request from a user device for access to an application; means for obtaining user-specific attributes for the application from an identity management system; and means for accessing the application in accordance with the user-specific attributes. In some embodiments of the invention, some of the elements of the invention may be combined. For example, the means for receiving a request from a user device and the means for obtaining first user identification information from the user device may be provided by a single hardware or software element. The computer program product may further comprise means for obtaining first user identification information, for example from the user device. The computer program product may be provided on, or in the form of, an identity stick or some other apparatus that may be removably connected to the user device.

In some forms of the invention, the user-specific attributes comprise user credentials, such as login data. The user credentials may be required by the application in order to grant the user access to the application. The step of providing user-specific attributes to the application may comprise providing user credentials to the application. Thus, in some forms of the invention, it is possible to provide user credentials for a particular application to that application, without the user credentials needing to be provided to the user device being used.

The controller may include a central processing unit. The controller may include memory storing a software module.

The controller may be implemented as a software module. In such an arrangement, the software module used to control the access of an end user device to an application does not need to be stored at the end user device, thereby improving security.

In one form of the invention, the apparatus is adapted to be removably connectable to the user device and may, for example, be a flash memory device. The apparatus may be adapted to be removably connectable via a direct physical connection, such as a USB port of the user device. The provision of a direct physical connection is not required in all forms of the invention; for example, a wired or wireless connection could be provided. Indeed, the connection could be remote (for example via a network). In the event that the user device is a mobile communication device, such as a mobile telephone, the apparatus of the present invention may be incorporated in the mobile communication device, for example as a hardware or software module, or may be provided as a removable module, or may be adapted to be wirelessly connectable to the mobile communication device.

The controller may be arranged to communicate with the identity management system via a network, such as an Intranet or the Internet.

The controller may be arranged to communicate with the application via a network, such as an Intranet or the Internet.

The apparatus of the invention may be connectable to any one of a plurality of user devices. Thus, a user may be able to access secure resources using the apparatus of the present invention from any one of a number of user devices. Thus, the invention can provide both security and convenience for the user.

The invention may include obtaining first user identification information (for example, from the user device). In some forms of the invention, the first user information can be obtained using identification hardware of said user device. The invention may further include the step of determining what hardware is available for identifying the user. The invention may further include selecting between a number of available hardware options for identifying the user. By way of example, identification hardware may include fingerprint readers and other biometric sensors. Of course, other identification hardware options are available. In some forms of the invention, in the event that no suitable identification hardware is detected, the user may be prompted to enter a username and/or a password.

In use, the apparatus of the invention may act as a proxy between the user and the application, with data passing to/from the user and to/from the application via the proxy. Indeed, the apparatus of the invention may act as a multi-protocol proxy for applications residing on the user end device or on the apparatus itself. For example, the apparatus may not only provide the authentication/identification functionality, but also modification of communications, so that data which comes from an application is modified before reaching its destination. Thus, for example, if an email is sent, the apparatus could automatically provide a digital signature, without the local device being aware of this.

As described above, the apparatus of the invention may be used to provide a user with access to an application. In some aspects of the invention, subsequent communications between the user and the application need not make use of the apparatus of the invention.

If the apparatus of the present invention is a mobile communication device, such as a mobile telephone, then the application may also reside directly on the mobile communication device itself.

The apparatus of the present invention may be portable. Providing a portable apparatus (for example in the form of an identity stick) enables a user to carry the apparatus from one user device to another in a convenient manner.

Exemplary embodiments of the present invention are described below, by way of example only, with reference to the following numbered drawings.

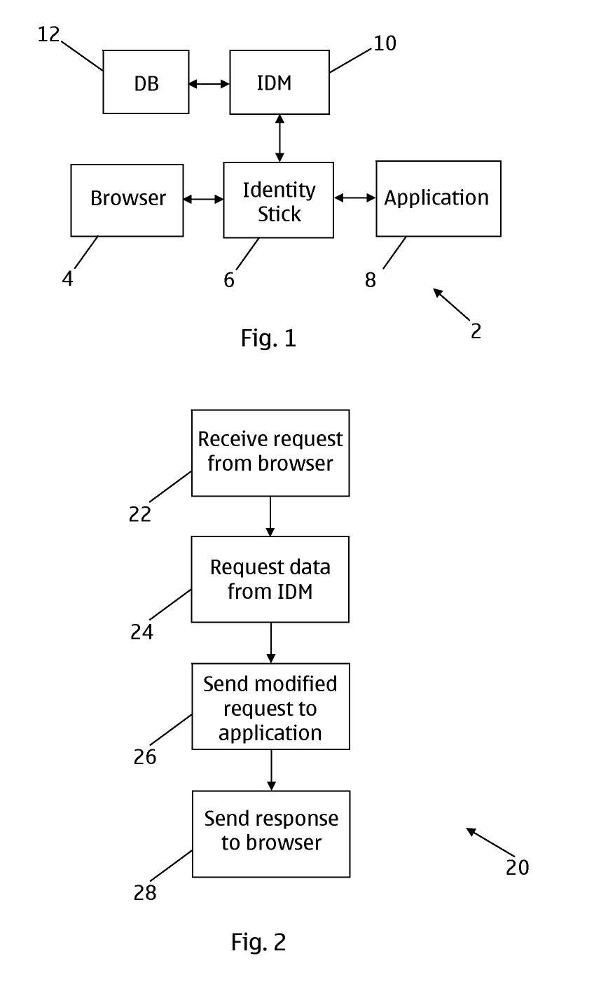

FIG. 1 is a block diagram of a system in accordance with an aspect of the present invention;

FIG. 2 is a flow chart demonstrating an aspect of an exemplary use of the system of FIG. 1;

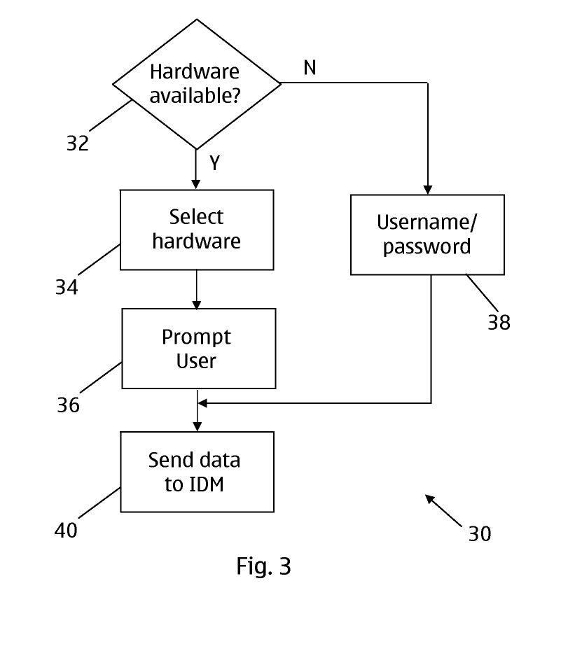

FIG. 3 is a flow chart demonstrating an aspect of an exemplary use of the system of FIG. 1;

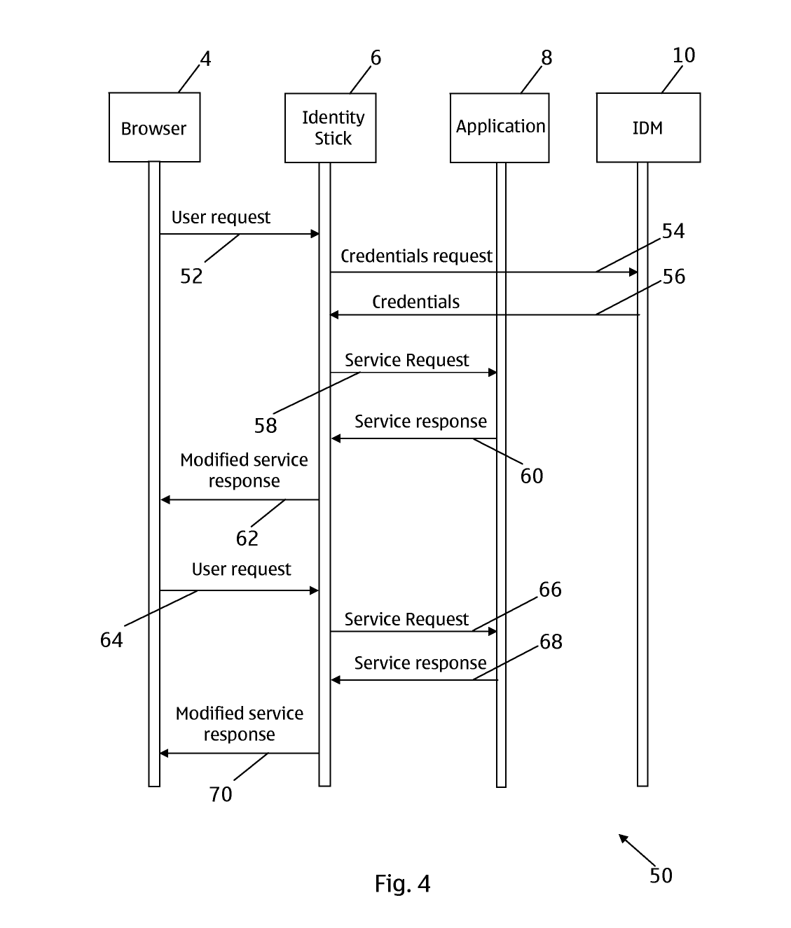

FIG. 4 is a message sequence demonstrating an aspect of the operation of the system of FIG. 1;

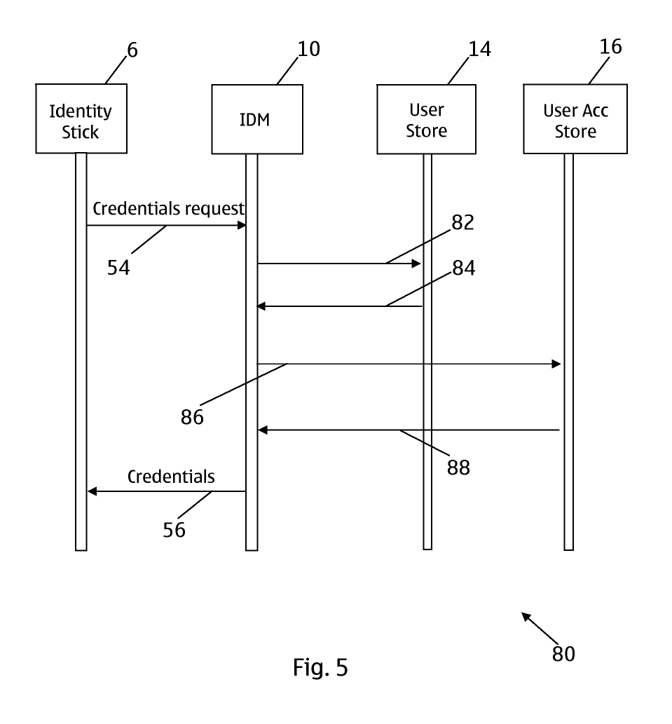

FIG. 5 is a message sequence demonstrating a further aspect of the operation of the system of FIG. 1; and

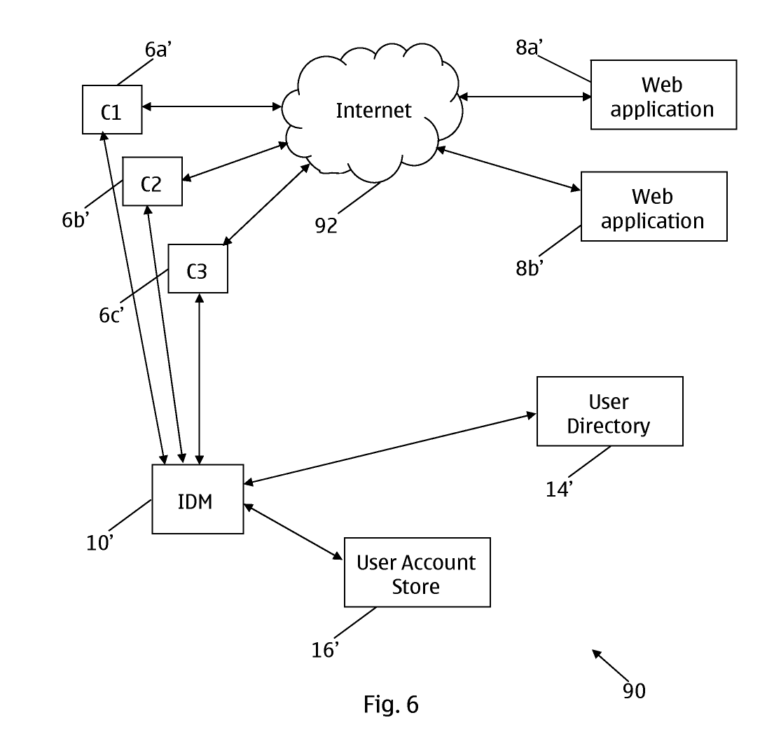

FIG. 6 is a block diagram of a system in accordance with an aspect of the present invention.

FIG. 1 is a block diagram of a system, indicated generally by the reference numeral 2, in accordance with an aspect of the present invention. The system 2 comprises a user browser 4, an identity stick 6, an application 8, an identity management system (IDM) 10, and a database 12 operatively coupled to the IDM 10. The identity stick 6 is coupled between the browser 4 and the application 8 and is also coupled to the IDM 10. The identity stick 6 is in two-way communication with each of the browser 4, the application 8 and the IDM 10.

In use, the user browser 4 and the identity stick 6 are at a user machine. The identity stick 6 may, for example, be a flash memory card that is removably connected to the user's machine, for example via a USB port. The identity stick typically communicates with the application 8 and the IDM 10 via a network, such as the Internet.

The identity stick 6 includes pre-installed software that is used to control the functionality of the identity stick. In particular, the software controls the interactions between the user and the identity stick, and also between the identity stick and the IDM 10. The identity stick can also be used to store data, such as user data.

FIG. 2 is a flow chart showing an exemplary algorithm, indicated generally by the reference numeral 20, for the use of the system 2.

The algorithm 20 starts at step 22, where a request to access the application 8 is received by the identity provider 6 from the browser 4. In response to receiving the request from the browser, the identity provider may seek identification details for the user of the browser, as discussed further below. For example, the identity stick may obtain identification information from the user (for example in the form of a username/password pair, or in the form of a fingerprint sample, or by providing generic bootstrapping architecture (GBA) mechanisms).

The algorithm 20 moves to step 24, where the identity stick 6 requests data from the IDM 10 to enable access to be given to the application 8. This data may take many different forms. Typically, the data includes user-specific attributes for the application 8, such as user credentials required to access the application or user authorisations and policies. In order to obtain such user-specific attributes, the identity stick 6 may need to identify the user of the browser to the satisfaction of the IDM 10. Alternatively, or in addition, the data obtained from the IDM 10 may include a uniform resource locator (URL) for the application, or any other information that enables the identity stick to communicate with the application.

Next, at step 26, the request received from the browser 4 to access the application 8 is modified under the control of the identity stick 6 to add data obtained from the IDM 10. For example, the identity stick may add user credentials to the request, as required by the application 8. Alternatively, or in addition, the identity stick may add a URL for the application 8. The modified request is then sent to the application 8.

Next, the identity stick 6 receives a response from the application 8 and sends that response to the browser at step 28. In some forms of the invention, the identity stick 6 modifies the response from the application before forwarding the response to the browser.

The user of the browser 4 may proceed to send further requests to the application 8 via the identity stick 6 and the application may proceed to send multiple responses to the browser via the identity stick. Thus, the identity stick 6 acts as a proxy. Alternatively, once the user has been granted access to the application 8, further communications between the browser 4 and the application 8 may be conducted directly, without requiring the use of the identity stick 6.

As mentioned above, the step 22 of the algorithm 20 may include the identity stick 6 obtaining identification information from the user. In one form of the invention, identity stick 6 makes use of available hardware, such as a fingerprint sensor or a smart card reader to obtain suitable identification information for passing to the IDM. This process is controlled by the software installed on the identity stick 6. A possible algorithm for this process, indicated generally by the reference numeral 30, is shown in FIG. 3.

The algorithm 30 starts at step 32, where the software at the identity stick 6 determines whether suitable hardware, such as a fingerprint reader or a smart card reader, is available for identifying the user. If such hardware exists, the identity stick selects hardware to be used for identifying the user in step 34 and then prompts the user to use the hardware (step 36). If no such hardware exists, then the algorithm 30 moves from step 32 to step 38, at which step the user is prompted to enter a username and/or a password. In some forms of the invention, the step 36 is omitted since the user does not need to be prompted. This might be the case, for example, if generic bootstrapping architecture (GBA) mechanisms are used, since in such a case there would be nothing for the user to do, and therefore no need to prompt the user.

The algorithm 30 moves from either step 36 or step 38 to step 40 (or directly from step 34 to step 40 if step 36 is omitted), at which step the data obtained from the user is passed to the IDM 10 and the IDM asked to provide credentials for the user that are required to access the application 8.

In one implementation of the present invention, the identity stick 6 is used by a user to gain access to secure resources from a shared computer resource, for example in an Internet café. In such environments, the hardware available to identify the user may vary considerably from location to location. The algorithm 30 enables the identity stick 6 to make use of the resources that are available in any particular location for identifying the user to the satisfaction of the IDM 10.

The selection made at the step 34 may be dependent on the requirements of the IDM 10, or may be dependent on the requirements of an application being accessed. If the selection is application dependent, then the algorithm 30 might only be executed after a user has requested access to a particular application.

Of course, the algorithm 30 is just one of many algorithms that could be used for obtaining identification information from the user. Other possibilities include GBA, TCA/TPM or a public key infrastructure (PKI) solution (in which case the identity stick would contain a PKI application programming interface (API) and a secure storage). The skilled person will be aware of further suitable arrangements that could be used.

The algorithm 20 described above demonstrates an exemplary use of the system 2. FIG. 4 shows an exemplary message sequence, indicated generally by the reference numeral 50, showing messages that may be transferred between the browser 4, identity stick 6, application 8 and IDM 10 when the algorithm 20 is executed.

The message sequence 50 begins with the user using the browser 4 to issue a request 52 to access the application 8, which application requires the identity of the user to be verified before access is granted. The user request 52 is sent from the browser 4 to the identity stick 6. The identity stick 6 liaises with the IDM 10 in order to obtain credentials for the user. This is achieved by the identity stick 6 sending a credentials request 54 to the IDM 10 and the IDM returning credentials in a message 56. The request 54 may include a request for other information, such as a request for the URL of the application 8.

The identity stick 6 is now in possession of credentials for the user and modifies the user request 52 to include the user credentials. The modified request is sent as service request 58 to the application 8. In response, the application grants the user access to the application and returns a service response 60 to the identity stick 6. The identity stick 6 may modify the response from the application and send the response (either in modified form or as provided by the application) to the browser 4 as message 62.

The user may then send one or more further requests 64 to the application 8, which requests are sent initially to the identity stick 6, which identity stick forwards the service request to the application as message 66. The application 8 sends service responses 68 to the identity stick in response to the request 66, which responses are sent (possibly in modified form) from the identity stick to the browser 4 as message 70.

Thus the identity stick 6 acts as a proxy between the browser 4 and the application 8. The identity stick is able to obtain user credentials from the IDM 10 and to communicate those credentials to the application 8, without requiring any user data to be stored at the user's machine. Furthermore, no special software is required to be installed at the user's machine; therefore the algorithm is portable.

By using an identity stick 6, the user's end device does not need special hardware to be installed, because the software installed on the stick can be adapted to find and make use available mechanism to identify the user to the satisfaction of the IDM 10.

If the user wants to access a special service (such as a restricted corporate service), the identity managing software on the stick asks the IDM 10 for permission and for the user's credentials for the service, alters the communication between the end device and the service, for example by inserting credentials (e.g. cookies) into the request in a manner that is invisible to the end user. The software on the identity stick may also modify responses from the application 8 before they reach the browser 4. In this manner, the user is anonymised (e.g. by filtering the cookies and saving them at the identity stick 6) and can also be provided with restricted content (e.g. by adding corporate specific data to all web pages accessed by the user). By obtaining the user's credentials and access criteria (such as the URL of the application 8) from the IDM 10, there is no need for the user to remember them, which improves convenience for the end user as well as security. Further, an administrator now has a single place where he can manage all access data and provide them to users without contacting them directly.

Once the user leaves the end device, he simply needs to remove the identity stick 6 from the user equipment. Since no data is saved at the end device, the user's privacy and authenticity are protected and the next user will not be able to access that content. Furthermore, if the user now connects the identity stick 6 to another device, he may reuse cookies stored on the identity stick 6 to continue using the application 8, often as if he had never changed the end user device being used.

As discussed above, the identity stick 6 can access user credentials stored at the IDM 10, with those user credentials being supplied to the application 8 without the browser 4 needing to have access to those user credentials. Accordingly, it is not necessary for the user even to know the user credentials. By way of example, the IDM 10 may store a username and password required to access a particular application 8. The application may require the password to be changed periodically, with that new password being stored at the IDM 10. If the user accesses the application 8 via the arrangement described in the present application, then the user can gain access to the application without needing to know the new password. Thus, user credentials can be changed without informing the user, thereby providing improved security.

The identity stick 6 may include a hardware authentication mechanism implemented (e.g. using special keys) which cannot be read out (due to protected and encrypted storage, in a similar manner as is known for Subscriber Identity Module (SIM) cards, for example), but the identity stick provides methods to use them (e.g. due to a signature Application Programming Interface (API)). Thus, the application on the identity stick authenticates the user with one of the existing methods (e.g. using a smart card reader or a fingerprint reader) to the IDM 10, reads the user's authorisations and policies at the IDM 10, handles further authentication to services that the user wishes to access (e.g. by injecting the user's credentials for specific web pages) and may provide access to pages/services itself (e.g. by acting as a DNS or providing a VPN tunnel). The identity stick 6 may also store relevant data (e.g. cookies) in its memory; such data need not be forwarded to the user, thereby increasing security.

As discussed above with reference to FIG. 4, the identity stick 6 sends a credentials request 54 to the IDM 10 and the IDM returns credentials 56 to the identity stick. A variety of methods could be used by the IDM 10 for providing the credentials 56. One possible arrangement is described below with reference to FIG. 5.

FIG. 5 shows a message sequence, indicated generally by the reference numeral 80 that starts with the sending of the credentials request 54 from the identity stick 6 to the IDM 10 and ends with the sending of the credentials 56 from the IDM to the identity stick.

In response to receiving the credentials request 54, the IDM 10 communicates with a user store 14. The user store contains user data and the data received by the IDM 10 from the identity stick 6 can be used to identify the user. The message sequence 80 shows a single message 82 being sent from the IDM 10 to the user store 14 and a single reply 84 being sent from the user store 14 to the IDM 10. Of course, the exchange between the IDM 10 and the user store 14 may include more that one message being sent in each direction. The user store may, for example, be an ActiveDirectory or AAA (Authentication, Authorization and Accounting) system.

On receipt of the message 84 identifying the user, the IDM 10 sends a message 86 to a user account store 16. The user account store 16 stores user-specific attributes for the application 8 that the user is seeking to access. The user-specific attributes may include login data, but are not limited to login data. The user account store 16 returns user data to the IDM 10 in a message 88.

At this stage, the IDM 10 is in possession of data (the message 84) identifying the user and data (the message 88) providing user-specific attributes for the application 8. Next, the IDM 10 prepares the credentials required by the identity stick and sends those credentials to the identity stick in the message 56. Thus, the arrangement of FIG. 5 shows how user credentials can be provided in circumstances where the user identification information and the user credentials for a particular application are not provided in a common database.

The user store 14 and user account store 16 provide the functionality of the database 12 described above with reference to FIG. 1. Of course, the user store and user account store could be provided in a single database. Furthermore, many alternative arrangements will be apparent to persons skilled in the art. For example, telecommunications operators use a lot of software module, each of which provide different functionality. For example, an AAA-server may provide a method to authenticate a user, with an IDM being used to “translate” the different identities. A database may then be used to store application configuration information and a further database may be used to hold user-specific data for particular applications.

FIG. 6 is a block diagram, indicated generally by the reference numeral 90, of a system in accordance with an aspect of the present invention. The system 90 shows a number of users (and associated identity sticks) 6a′, 6b′, 6c′ accessing a number of web applications 8a′, 8b′ via the Internet 92. The system 90 includes an IDM 10′ that is in communication with a user account directory 14′ and a user account store 16′ and with the users 6a′, 6b′ and 6c′. The system 90 shows how an IDM 10′ can make use of two different databases (the user directory 14′ and the user account store 16′) for providing multiple users with access to multiple applications.

The arrangements of the present invention can be used to provide single-sign-on (SSO) functionality for a user. The user can identify himself and the application to which access is desired to the identity stick and the identity stick can obtain user credentials for that application. The user need only remember the user credentials required to identify himself to the satisfaction of the IDM 10, which credentials may be same for all applications for which the IDM holds user credential data.

As described above, the present invention can be used in an Internet café environment, where a user wishes to gain access to secure resources in circumstances where other users may have access to the same equipment at a different time; however the invention is not so limited. For example, the present invention can be used in a corporate environment to control access to a number of applications. Consider the scenario in which a number of employees of a company are given a laptop computer and a flash memory card. The laptop computer includes the browser 4 and the flash memory card provides the identity stick 6 of the system 2. The flash memory card can be programmed by the company to enable a particular user to gain access to certain applications provided by the company. In this way, the company can control which users have access to which applications, without needing to change the setup of the computers.

The identity stick 6 may be a flash memory card, such as a USB memory stick; however this is not essential. The identity stick could be any portable device that can be used to store data and which is compatible with the device that the user wishes to use to access applications. For example, the identity stick could be a rich smartcard or a mobile telephone.

Embodiments of the present invention include at least some of the following advantages:

The identity stick 6 can be used as a deposit of user profile data.

The identity stick 6 can be used for service with “special” requirements, e.g., services with confidential content (such as Internet banks and company Intranets).

The identity card 6 can replace previous systems, such as the use of HBCI cards (that are widely used in Germany for accessing bank accounts) or one time key systems

The identity stick 6 can be used in conjunction with a SIM-based device to provide the SIM-based device with easy access to secure services.

The identity stick 6 can be used in combination with TCA/TPM mechanisms for secure handling of data.

The identity stick 6 can be used as a portable cookie store. Cookies can be saved to the stick and transported to a new location. Thus, the browser 4 need not store the cookies.

Systems in accordance with the invention can readily combine the use of an identity stick 6 as an identification means and the use of an IDM 10 as a gateway.

The identity stick 6 can be used for the verification and validation of software licenses.

Passwords can be changed and stored at the identity provider, without needing to inform the user. For example, periodically changing passwords can be changed automatically and the new password details stored.

The embodiments of the invention described above are illustrative rather than restrictive. It will be apparent to those skilled in the art that the above devices and methods may incorporate a number of modifications without departing from the general scope of the invention. It is intended to include all such modifications within the scope of the invention insofar as they fall within the scope of the appended claims.

1. An apparatus comprising:
a controller;
a first interface adapted to enable the controller to communicate with a user device;
a second interface adapted to enable the controller to communicate with an identity management system in order to obtain user-specific attributes for an application; and
a third interface adapted to enable the controller to communicate with the application, in accordance with the user-specific attributes.

2. An apparatus as claimed in claim 1, wherein the user-specific attributes comprise user credentials.

3. An apparatus as claimed in claim 1, wherein the apparatus is adapted to be removably connectable to the user device.

4. An apparatus as claimed in claim 1, wherein the apparatus is a flash memory card.

5. An apparatus as claimed in claim 1, wherein the second interface is adapted to enable the controller to communicate with the identity management system via a network.

6. An apparatus as claimed in claim 1, wherein the third interface is adapted to enable the controller to communicate with the application via a network.

7. An apparatus as claimed in claim 1, wherein the apparatus is connectable to any one of a plurality of user devices.

8. An apparatus as claimed in claim 1, wherein the first interface is adapted to obtain first user information from the user device.

9. An apparatus as claimed in claim 8, wherein the first user information is obtained using identification hardware of said user device.

10. A method comprising:
receiving a request from a user device for access to an application, the request being received at a second device;
using the second device to obtain user-specific attributes for the application from an identity management system; and
using the second device to access the application in accordance with the user-specific attributes.

11. A method as claimed in claim 10, further comprising obtaining first user identification information.

12. A method as claimed in claim 11, wherein the first user identification information is obtained from the user device.

13. A method as claimed in claim 11, further comprising the use of the first user identification information when obtaining the user-specific attributes.

14. A method as claimed in claim 11, further comprising the use of identification hardware of the user device to obtain said first user identification information.

15. A method as claimed in claim 14, further comprising selecting said identification hardware from a plurality of identification hardware options.

16. A method as claimed in claim 10, wherein the user-specific attributes comprise user credentials, which user credentials are required by the application in order to grant the user access to the application.

17. A method as claimed in claim 16, wherein accessing the application includes providing the user credentials to the application.

18. A method as claimed in claim 10, further comprising communicating with the identity management system and/or the application via a network.

19. A method as claimed in claim 10, further comprising acting as a proxy between the user device and the application.

20. A method as claimed in claim 10, wherein the second device is removably connected to the user device.

21. A computer program, comprising:
code for receiving a request from a user device for access to an application;
code for obtaining user-specific attributes for the application from an identity management system; and
code for accessing the application in accordance with the user-specific attributes as follows.
